(19) United States
(12) Patent Application Publication
(10) Pub. No.: US 2020/0247707 A1
(43) Pub. Date: Aug. 6, 2020

(54) Glass Bottle Cutter

(71) Applicant: Constantin Olaru, Bucharest (RO)

(72) Inventor: Constantin Olaru, Bucharest (RO)

(21) Appl. No.: 16/265,996

(22) Filed: Feb. 2, 2019

(51) Int. Cl. C03B 33/06; C03B 33/10

(52) U.S. Cl. CPC C03B 33/06; C03B 33/105

(57) ABSTRACT

The present invention comprises a new glass bottle cutting device generally used for standard sizes bottles, with an adjustable length for up to 19.5-inch bottles. The device consists of a base, an L shaped backstop, rollers (wheels), and a carbide blade. When using it the blade scores the glass bottle so that you can split it into two parts with little effort.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### Field of the Invention

The present invention generally relates to a glass-cutting tool and, more particularly, to a tool for cutting a glass bottle.

### Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Bottle cutting is an art or craft that enables a person to make drinking glasses, vases or other artistic creations from empty glass bottles such as beer bottles, wine bottles, liquor bottles, soft drink bottles, or the like.

A variety of bottle-cutting tools or bottle cutters are known in the art. Some examples of prior-art bottle cutters are disclosed in U.S. Pat. Nos. 3,699,829; 3,744,359; 3,744,692; 3,845,555; 3,902,643; 6,811,477; and in PCT International Patent Application Publication WO/2007/129877. However, these devices tend to be either big, bulky or not aesthetic.

None of the prior art methods have been found to be completely suitable to meet these needs and some are cumbersome. The present invention provides a bottle cutter that is smaller, easier to use and more aesthetic and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

In order to solve the above problems, the proposed invention comprises of a new glass bottle cutting device generally used for standard sizes bottles, with an adjustable length for up to 19.5-inch bottles. The device consists of a base, an L shaped backstop, rollers (wheels), and a carbide blade. When using it the blade scores the glass bottle so that you can split it (cut it) into two parts with little effort.

Another preferred embodiment is the method of production of the glass cutter, the cutter can be adjusted to the bottle length by using the L shaped backstop for positioning and supporting the bottles, so that when the bottle is rotated forward or reverse, you will obtain a straight score to cut the glass bottle, the L shaped backstop can be adjusted for a longer bottle, or it can be adjusted to a smaller bottle, easy to operate.

This novel design is compact (thus easy to store), simple to use, and reliable in that it consistently cuts bottles in a safe, predictable and efficient manner.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 a side perspective view of the device and enumerates the components.

FIG. 2 is an illustration of side perspective view of the device from a different angle.

FIG. 3 shows an example of how the glass bottle must be placed on the device to begin using it.

FIG. 4 depicts an example of the device being used to score a glass bottle.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings and described in the following specification, are simply exemplary embodiments of the inventive concepts defined in the appended claims. Specific dimensions and other physical characteristics relating to the embodiments disclosed herein are therefore not to be considered as limiting unless the claims expressly state otherwise.

As presented in FIG. 1 depicts an example of the device and presents its components. The components of the device presented in FIG. 1 are as follow. 10. The L-shaped backstop is used to place the glass bottle firm against it when scoring. The role of this backstop is to prevent the score from being duplicated and to keep the score straight. The L shaped backstop can be manufactured out of metal, wood or plastic; 12. The base of the device is used to place all the components of the device on it. The material of the base can be wood, a metal or plastic; 14. The rollers are placed on the base so that the glass bottle can be easily rotated for scoring. There can be different numbers of rollers placed on the base, depending on the size of bottle that is going to be scored. The support rollers can be made out of plastic, rubber, metal or wood; 16. The roller supports are used to fix the rollers to the base. They can be made out of plastic, metal or wood; 18. The blade support is used to fix the blade on the base. It can be made out of plastic, metal or wood; 20. The carbide blade is fixed on the base and it is used to score the glass bottle; 22. The backstop adjustment screw is used to adjust the position of the L shaped backstop, depending on the size of the glass bottle that is being scored.

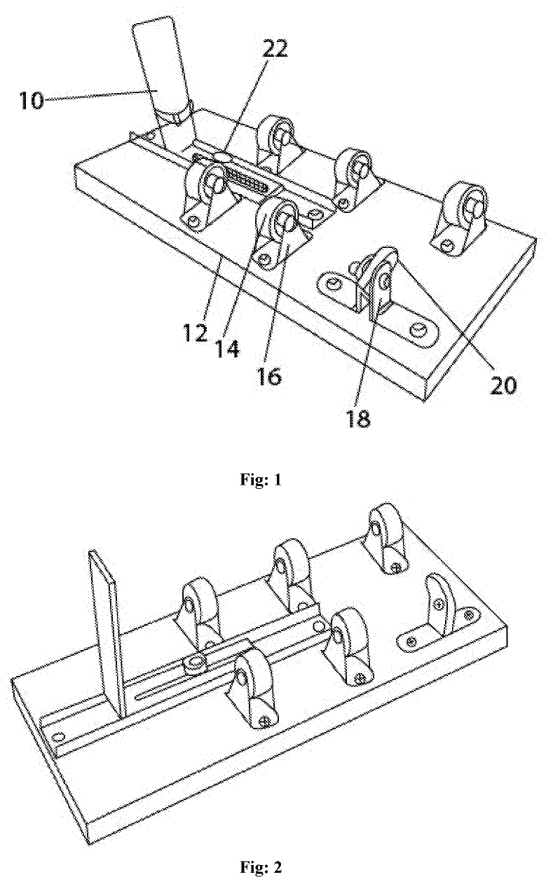

FIG. 2 depicts an example of the device presented from a side angle.

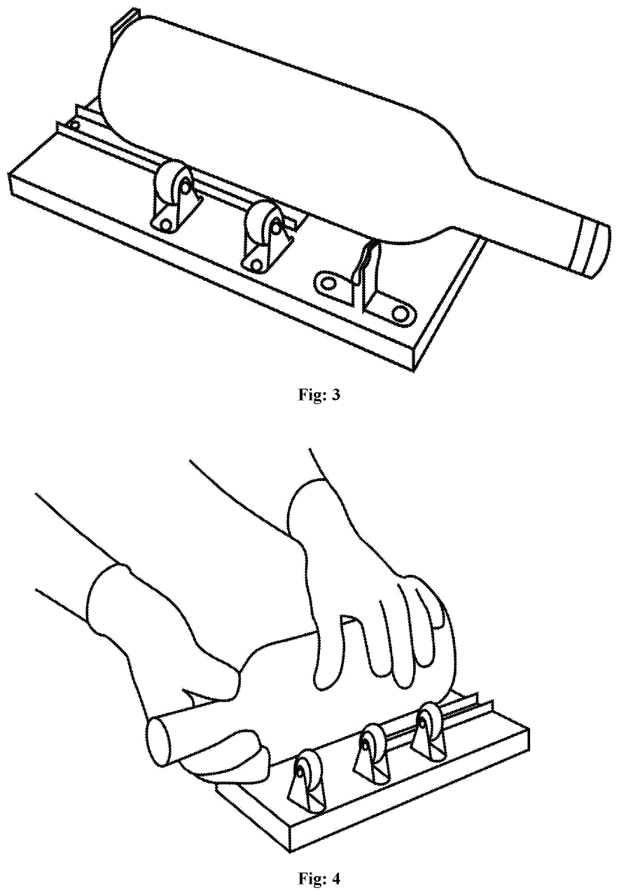

FIG. 3 depicts an example of positioning a glass bottle on the device and against the L shaped backstop before starting to score it. The bottle must be placed lengthwise on the device with the bottom against the backstop and resting on the rollers. The position of the backstop determines the point at which the bottle will be scored. To adjust the length, one must loosen the screw and slide backstop forward for a shorter cut and backward for a longer cut.

FIG. 4 depicts an example of the device being used for scoring a bottle. After placing the bottle on the cutter a light etch is all that is required. One must apply only medium pressure on the bottle while rotating the bottle toward him with using his hands. To assure an accurate cut, the bottle must be kept firm against the L shaped backstop. One must not allow the bottle to stop turning until a complete circle is finished. A slight crunching sound will signal the completion of the circle. One complete scoring circle of the bottle is all that is necessary, one does not have to score over after the circle is finished, the score must not be duplicated. If the etch is properly scribed the ends will meet.

The bottle cutter may be used to cut a variety of glass or glass-like bottles such as wine bottles, beer bottles, liquor bottles, soft drink bottles, water bottles etc. In addition, the bottle cutter may be used to cut any other hollow tubular glass or glass-like structure.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1) A bottle cutting device that can be adjusted to the bottle length by using an L shaped designed backstop, as shown and described.
